(19) United States
(12) Patent Application Publication
(10) Pub. No.: US 2023/0100644 A1
(43) Pub. Date: Mar. 30, 2023

(54) COMPUTER-READABLE RECORDING MEDIUM STORING MACHINE LEARNING PROGRAM, MACHINE LEARNING APPARATUS, AND METHOD OF MACHINE LEARNING

(71) Applicant: FUJITSU LIMITED, Kawasaki-shi (JP)

(72) Inventors: Masahiro ASAOKA, Kawasaki (JP); Yasufumi SAKAI, Fuchu (JP); Akihiko KASAGI, Kawasaki (JP)

(73) Assignee: FUJITSU LIMITED, Kawasaki-shi (JP)

(21) Appl. No.: 17/857,179

(22) Filed: Jul. 5, 2022

(30) Foreign Application Priority Data
Sep. 28, 2021 (JP) 2021-157771

(51) Int. Cl. G06N 20/00

(52) U.S. Cl. CPC G06N 20/00

(57) ABSTRACT

A process includes, wherein a subset of elements of first training-data that includes elements is masked in second training-data, generating, from the second training-data, third training-data in which a subset of elements of data that includes output of a generator that estimates an element appropriate for a masked-portion in the first training-data and a first element other than the masked-portion in the second training-data is masked, and updating a parameter of a discriminator, which identifies whether the first element out of the third training-data replaces an element of the first training-data and which estimates an element appropriate for the masked-portion in the third training-data, so as to minimize an integrated loss function obtained by integrating first and second loss functions that are calculated based on output of the discriminator and the first training-data and that are respectively related to an identification result and an estimation result of the discriminator.

### CROSS-REFERENCE TO RELATED APPLICATION

This application is based upon and claims the benefit of priority of the prior Japanese Patent Application No. 2021-157771, filed on Sep. 28, 2021, the entire contents of which are incorporated herein by reference.

### FIELD

The embodiment discussed herein is related to a computer-readable recording medium storing a machine learning program, a machine learning apparatus, and a method of machine learning.

### BACKGROUND

Machine learning models of related art that use pre-training represented by a Bidirectional Encoder Representations from Transformers (BERT) have realized the highest accuracy in many natural language processing benchmarks. These machine learning models create a general-purpose pre-trained model by using large-scale unlabeled data and perform transfer training corresponding to application by using the pre-trained model, for example, by using small-scale labeled data corresponding to application such as machine translation or a question and answer. A representative technique of the pre-training is based on a Masked Language Modeling (MLM). The MLM gives to a machine learning model problems in which statistically masked words in input text are estimated based on words in the proximity of the masked words.

However, in the MLM, machine learning is actually performed only in the proximity of the masked words. Thus, learning efficiency depends on a probability of masking. When the probability of masking is increased in order to improve the learning efficiency, data in the proximity that serves as hints for estimating the masked words decreases. In this case, problems are not established, and accordingly, there is a problem in that the learning efficiency is unlikely to be improved.

To address this problem, an Efficiently Learning an Encoder that Classifies Token Replacements Accurately (ELECTRA) has been proposed. The ELECTRA includes two types of neural networks, a generator and a discriminator. The generator is a small-scale MLM having a similar configuration to that of the BERT, estimates masked words from input text with a subset thereof masked, and generates text similar to the input text. A technique called a Replaced Token Detection (RTD) that detects portions where the words are replaced by the generator is applied to the discriminator. Machine learning in which the generator and the discriminator are combined is performed in pre-training of the ELECTRA. With the ELECTRA, the presence or absence of replacement is determined not only in the proximity of the masked words but for all the words in the input text. Thus, compared to the MLM or other existing methods, the learning efficiency is high and the learning may be performed at high speed.

A technique related to machine learning in a configuration including the generator and the discriminator has been proposed. For example, there has been proposed a training apparatus that receives a training data group that is a set of graph structure data including an edge having a plurality of attributes and performs mask processing on a subset of the training data group, so that deficient training data in which the training data group is deficient is generated. This training apparatus extracts features of the edge included in the deficient training data and extracts features of graph structure data corresponding to the deficient training data based on the extracted features. Based on the training model for estimating the graph structure data having no deficiency from the deficient graph structure data and the extracted features, the training apparatus trains the training model so as to estimate the graph structure data having no deficiency and outputs the trained model after training.

International Publication Pamphlet No. WO 2021/111499 is disclosed as related art.

### SUMMARY

According to an aspect of the embodiments, a non-transitory computer-readable recording medium storing a machine learning program for causing a computer to execute a process, the process includes, wherein a subset of elements of first training data that includes a plurality of elements is masked in second training data, generating, from the second training data, third training data in which a subset of elements of data that includes output of a generator that estimates an element appropriate for a masked portion in the first training data and an element other than the masked portion in the second training data is masked, and updating a parameter of a discriminator, which identifies whether the element other than the masked portion out of the third training data replaces an element of the first training data and which estimates an element appropriate for the masked portion in the third training data, so as to minimize an integrated loss function obtained by integrating a first loss function and a second loss function that are calculated based on output of the discriminator and the first training data and that are respectively related to an identification result of the discriminator and an estimation result of the discriminator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining generation of a pre-trained model for transfer training;

FIG. 2 is a diagram for explaining a Masked Language Model (MLM);

FIG. 3 is a diagram for explaining a Replaced Token Detection (RTD);

FIG. 4 is a functional block diagram of a machine learning apparatus;

FIG. 5 is a diagram for explaining the function of a discriminator according to a present embodiment;

FIG. 6 is a diagram for explaining a machine learning process according to the present embodiment;

FIG. 7 is a block diagram schematically illustrating the configuration of a computer that functions as the machine learning apparatus; and

FIG. 8 is a flowchart illustrating an example of the machine learning process.

### DESCRIPTION OF EMBODIMENTS

The inventors have observed an event in which, in a Japanese benchmark task, the inference accuracy by using a machine learning model in which transfer training is performed by using a pre-trained model with the ELECTRA reaches a plateau and does not reach the inference accuracy with the BERT.

Hereinafter, with reference to the drawings, an example of an embodiment according to a technique that improves the inference accuracy by using a machine learning model having undergone transfer training while maintaining a training speed in machine learning of a pre-trained model usable for transfer training will be described.

First, before description of the details of the present embodiment, the ELECTRA, which is the premise of the present embodiment, will be described.

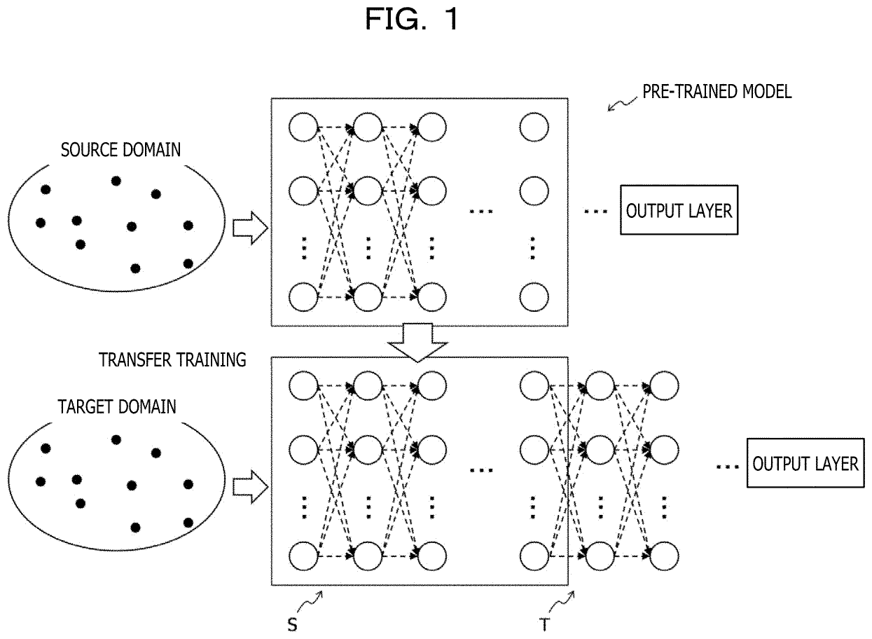

As a technique of generating a machine learning model for a predetermined task, there is a technique as described below. First, as illustrated in an upper part of FIG. 1, a training apparatus generates a general-purpose pre-trained model by using large-scale unlabeled data (“SOURCE DOMAIN” illustrated in FIG. 1). For example, the training apparatus uses the data in the source domain as training data and updates the respective weights in the layers of the machine learning model that includes, for example, a neural network, thereby to minimize a predetermined loss function. As illustrated in a lower part of FIG. 1, the training apparatus performs transfer training on the pre-trained model by using, as the training data, small-scale labeled data (“TARGET DOMAIN” illustrated in FIG. 1) corresponding to an individual task such as a question and answer or machine translation. Thus, the machine learning model corresponding to a task is generated. For example, in transfer training, the training apparatus retrains, by using the data of a target domain, the machine learning model for which the weights of the pre-trained model are copied (S illustrated in FIG. 1). As appropriate, the training apparatus may add a new layer to the network configuration of the pre-trained model (T illustrated in FIG. 1). As described above, by using a general-purpose pre-trained model, a machine learning model capable of realizing an individual task with high accuracy may be generated even when there is a small amount of data of the individual task.

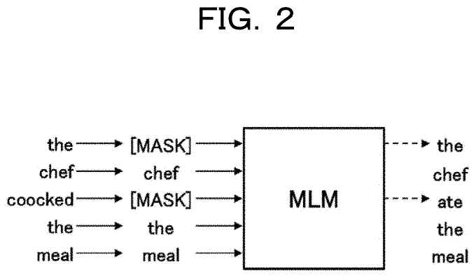

As a technique of generating a pre-trained model as described above, there is a technique called a Masked Language Model (MLM). As illustrated in FIG. 2, with the MLM, pre-training of a machine learning model that masks ([MASK]) a subset of words in input text and estimates the words appropriate for the masked portions is executed. The MLM is good in the following points: training data may be automatically generated by masking a subset of input text; and machine learning processing may be executed in parallel. However, with the MLM, only portions in the proximity of the masked portions are actually pre-trained. For example, with the BERT, words to be masked are usually 15% of the entirety. Accordingly, there is a problem in that machine learning of the machine learning model does not easily proceed.

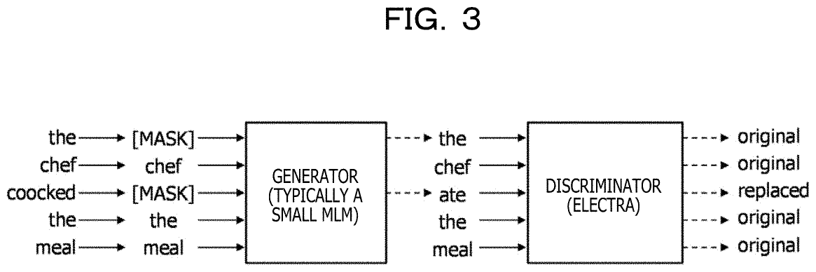

A technique proposed to address this problem is the ELECTRA. As a technique of pre-training, a Replaced Token Detection (RTD) is employed in the ELECTRA. As illustrated in FIG. 3, two types of neural networks for machine learning, a generator and a discriminator, are executed in the RTD. The generator is an MLM. The generator executes machine learning by receiving data with a subset of tokens (words) of unlabeled data masked so as to estimate the original tokens of the masked tokens. Since the main purpose of the ELECTRA is not to improve the estimation accuracy of the generator, the ratio of tokens to be masked is not desired to be increased. For example, in a case where the size of the machine learning model is the base size, 15% of all the tokens are masked, and in a case where the size of the machine learning model is the large size, 25% of all tokens are masked. The base size and the large size are the base size and the large size of three types of size (small, base, and large) of a model disclosed as a pre-trained model with the ELECTRA. In the discriminator, machine learning is executed by receiving the estimation results by the generator as input so as to identify whether the tokens are replaced (replaced) or not replaced (original) with the original input data. Since the machine learning is executed for all the input tokens in the RTD, compared to the BERT, the training speed until the predetermined accuracy is attained is high, for example, the training efficiency is high.

However, the inventors have observed the event in which the inference accuracy by using a machine model in which transfer training is performed by using the pre-trained model with the ELECTRA reaches a plateau and does not reach the inference accuracy with the BERT. As a cause of this, it is thought that, with the MLM, a problem to be solved is to select a word appropriate for a mask in text from all vocabularies (for example, 32,000 words) whereas, with the RTD, the problem is to select one of two items in that replaced or original is determined for all the words in the text. For example, the cause of the event in which the inference accuracy in the ELECTRA reaches a plateau is that, due to the poor complexity of the problem to be solved by machine learning with the RTD, the generalization property of the pre-trained model is decreased compared to the MLM with which a complex problem is solved. Thus, according to the present embodiment, machine learning for solving a complex problem is executed while training the entire input data, thereby, while maintaining the training speed, improving the inference accuracy by using the machine learning model after the transfer training. Hereinafter, a machine learning apparatus according to the present embodiment will be described.

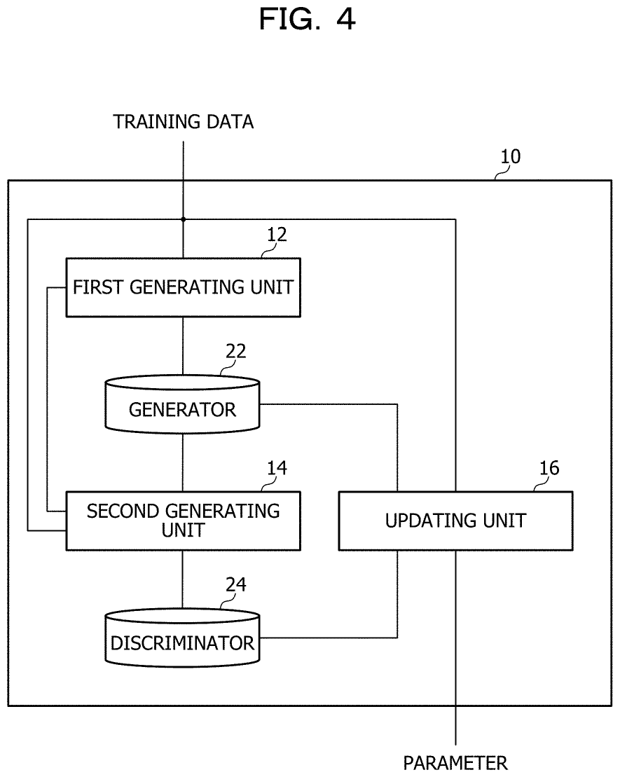

As illustrated in FIG. 4, a machine learning apparatus 10 functionally includes a first generating unit 12, a second generating unit 14, and an updating unit 16. A generator 22 and a discriminator 24 are stored in a predetermined storage area of the machine learning apparatus 10. The generator 22 is an example of a “generator” of the disclosed technique, and the discriminator 24 is an example of a “discriminator” of the disclosed technology.

The generator 22 is a machine learning model that is similar to the generator in the ELECTRA, that includes, for example, a neural network, and, that estimates and outputs, when data in which a subset of elements is masked is input, the elements appropriate for the masked portions.

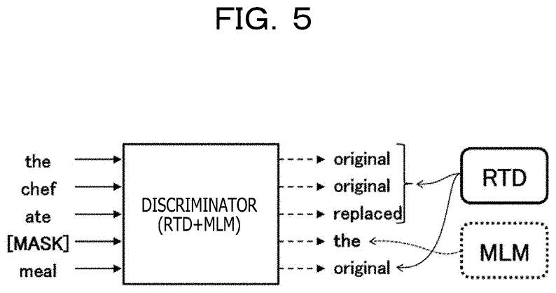

Also, the discriminator 24 is a machine learning model that includes, for example, a neural network. As illustrated in FIG. 5, when data in which a subset of elements is masked is input, the discriminator 24 according to the present embodiment identifies whether elements other than the masked portion replace the elements of the original data and outputs the results. The discriminator 24 estimates the element appropriate for the masked portion and outputs the result. For example, with the discriminator 24, the RTD is applied to elements other than masked portions of input data, and the MLM is applied to the masked portions of the input data.

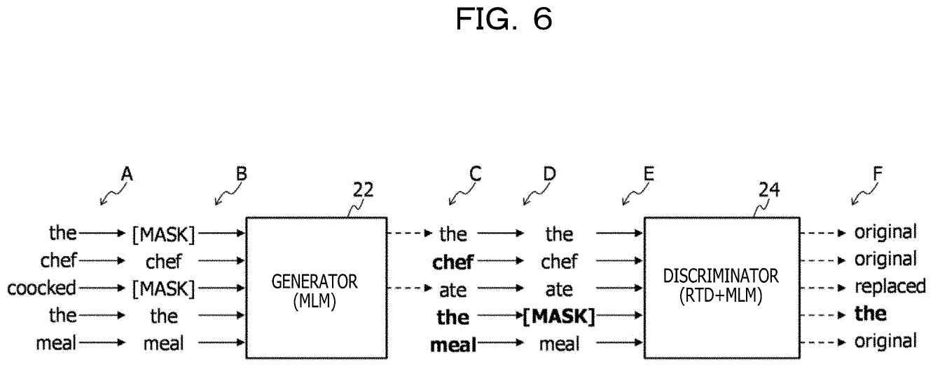

The first generating unit 12 obtains training data input to the machine learning apparatus 10. The training data is data including a plurality of elements. According to the present embodiment, a case where training data is text data included in text is described as an example. In this case, words included in the text correspond to “elements”. Hereinafter, the training data input to the machine learning apparatus 10 is referred to as “first training data”. As indicated by A illustrated in FIG. 6, the first generating unit 12 generates second training data in which a subset of words of the first training data is masked. The ratio of masking may be similar to that of the ELECTRA of related art or may be an empirically obtained value. In the example illustrated in FIG. 6, the first generating unit 12 generates the second training data in which the words “(first) the” and “cooked” of “the chef cooked the meal” in the first training data are masked ([MASK]). As indicated by B illustrated in FIG. 6, the first generating unit 12 inputs the generated second training data to the generator 22.

The second generating unit 14 generates intermediate data including the output of the generator 22 to the second training data and words other than the portions masked in the second training data. FIG. 6 illustrates an example in which the generator 22 estimates the first mask and the second mask in the input second training data as “the” and “ate”, respectively, and outputs them. In this case, the second generating unit 14 obtains the words “the” and “ate” estimated by and output by the generator 22. The second generating unit 14 also obtains the words “chef”, “(second) the”, and “meal” other than the portions masked in the second training data. As indicated by C illustrated in FIG. 6, the second generating unit 14 generates intermediate data “the chef ate the meal” from the obtained words.

The second generating unit 14 generates third training data in which a subset of the words of the generated intermediate data is masked. The ratio of masking may be an empirically obtained value. In so doing, the second generating unit 14 masks at least a subset of the words other than the portions masked when the second training data is generated from the first training data. The reason for this is that, by masking the word estimated in the generator 22, the number of words replaced by the generator 22 is decreased, thereby a decrease in speed of the machine learning with the RTD in the discriminator 24 is avoided. For example, by not masking a word that may be identified as the replaced by the RTD, machine learning with the RTD is not inhibited. Referring to the example illustrated in FIG. 6, as indicated by D illustrated in FIG. 6, the second generating unit 14 generates the third training data in which the word “(second) the” of the generated intermediate data is masked ([MASK]). As indicated by E illustrated in FIG. 6, the second generating unit 14 inputs the generated third training data to the discriminator 24.

In the case of this example, as indicated by F illustrated in FIG. 6, the discriminator 24 identifies whether the words “(first) the”, “chef”, “ate”, and “meal” other than the masked portion in the third training data are the original or replaced. The discriminator 24 estimates the words appropriate for the masked portions in the third training data and outputs the estimation results. The example illustrated in FIG. 6 illustrates the example in which the word appropriate for the masked portion in the third training data is estimated as “(second) the”.

The updating unit 16 updates the parameters of the generator 22 and the discriminator 24 so as to minimize a loss function, for example, represented by Expression (1) below.

$${min}_{{θ}_{G} , {θ}_{D}} {\sum }_{x ∈ X} {L}_{MLM} ( x , {θ}_{G} ) + λ {L}_{Disc} ( x , {θ}_{D} ) + μ {L}_{Disc 2} ( x , {θ}_{D} ) \qquad ( 1 )$$

Here, x is an element (here, a word) included in training data X, θ_{G} is the parameter of generator 22, and OD is the parameter of the discriminator 24. Also, L_{MLM}(x, θ_{G}) is a loss function related to the MLM of the generator 22. Also, L_{Disc}(x, θ_{D}) is a loss function related to the RTD of the discriminator 24, and L_{Disc2} (x, θ_{D}) is a loss function related to the MLM of the discriminator 24. Also, is a weight for L_{Disc}(x, θ_{D}), and p is a weight for L_{Disc2}(x, θ_{D}). For the values of and μ, the weight for L_{MLM}(x, θ_{G}) may be set to be smaller than the weight for L_{Disc}(x, θ_{D}) and the weight for L_{Disc2}(x, θ_{D}). This setting is to avoid a situation in which the machine learning of the RTD in the discriminator 24 does not progress because of an excessive increase in the accuracy of the generator 22.

For example, the loss function of Expression (1) is a loss function obtained by integrating L_{MLM}(x, θ_{G}), L_{Disc}(x, θ_{D}), and L_{Disc2}(x, θ_{D}). For example, the loss function is represented by a weighted sum of L_{MLM}(x, θ_{G}), L_{Disc}(x, θ_{D}), and L_{Disc2}(x, θ_{D}). A method of integrating the loss functions is not limited to the weighted sum. Hereinafter, the loss function represented by Expression (1) is referred to as an “integrated loss function”. Here, L_{Disc}(x, θ_{D}) is an example of a “first loss function” of the disclosed technique, L_{Disc2}(x, θ_{D}) is an example of a “second loss function” of the disclosed technique, and L_{MLM}(x, θ_{G}) is an example of a “third loss function” of the disclosed technique.

For example, the updating unit 16 calculates the loss function L_{MLM}(x, θ_{G}) based on an error (degree of mismatch) between words in the first training data corresponding to masked portions in the second training data and estimation results that are output from the generator 22. The updating unit 16 obtains correct answers of the presence or absence of replacement in the generator 22 from words other than the masked portions in the third training data and the corresponding words in the first training data. Then, the updating unit 16 calculates the loss function L_{Disc}(x, θ_{D}) based on an error (degree of mismatch) between the obtained correct answers and the identification results (original or replaced) that are output from the discriminator 24. The updating unit 16 calculates the loss function L_{Disc2}(x, θ_{D}) based on an error (degree of mismatch) between the words in the first training data corresponding to the masked portions in the third training data and estimation results obtained by estimating the masked portions in the discriminator 24.

Also, the updating unit 16 integrates L_{MLM}(x, θ_{G}), L_{Disc}(x, θ_{D}), and L_{Disc2}(x, θ_{D}) by using, for example, the weighted sum to calculate the integrated loss function as represented in Expression (1). The updating unit 16 back-propagates the value of the calculated integrated loss function to the discriminator 24 and the generator 22 and updates the parameters of the generator 22 and the discriminator 24 so as to decrease the value of the integrated loss function. The updating unit 16 repeatedly updates the parameters of the generator 22 and the discriminator 24 until an end condition of machine learning is satisfied. The end condition of the machine learning may be, for example, a case where the number of times of repetition of the updating of the parameters reaches a predetermined number, a case where the value of the integrated loss function becomes smaller than or equal to a predetermined value, a case where the difference between the value of the integrated loss function calculated last time and the value of the integrated loss function calculated this time becomes smaller than or equal to a predetermined value, or the like. The updating unit 16 outputs the parameters of the generator 22 and the discriminator 24 obtained when the end condition of the machine learning is satisfied.

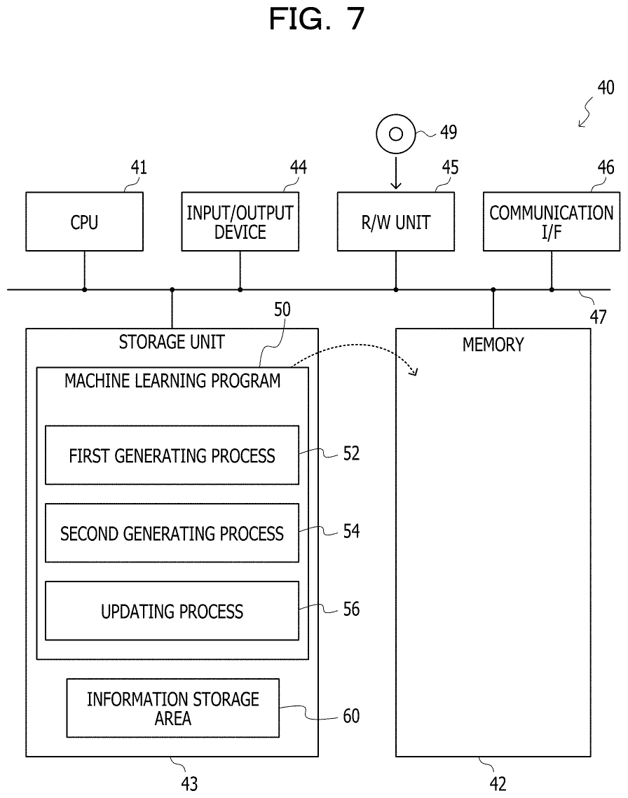

The machine learning apparatus 10 may be realized by, for example, a computer 40 illustrated in FIG. 7. The computer 40 includes a central processing unit (CPU) 41, a memory 42 serving as a temporary storage area, and a nonvolatile storage unit 43. The computer 40 also includes an input/output device 44 such as an input unit, a display unit, and the like and a read/write (R/W) unit 45 that controls reading and writing of data from and to a storage medium 49. The computer 40 also includes a communication interface (I/F) 46 that is coupled to a network such as the Internet. The CPU 41, the memory 42, the storage unit 43, the input/output device 44, the R/W unit 45, and the communication I/F 46 are coupled to each other via a bus 47.

The storage unit 43 may be realized by using a hard disk drive (HDD), a solid-state drive (SSD), a flash memory, or the like. The storage unit 43 serving as a storage medium stores a machine learning program 50 for causing the computer 40 to function as the machine learning apparatus 10. The machine learning program 50 includes a first generating process 52, a second generating process 54, and an updating process 56. The storage unit 43 includes an information storage area 60 in which information included in the generator 22 and information included in the discriminator 24 are stored.

The CPU 41 reads the machine learning program 50 from the storage unit 43, loads the read machine learning program 50 on the memory 42, and sequentially executes the processes included in the machine learning program 50. The CPU 41 executes the first generating process 52 to operate as the first generating unit 12 illustrated in FIG. 4. The CPU 41 executes the second generating process 54 to operate as the second generating unit 14 illustrated in FIG. 4. The CPU 41 executes the updating process 56 to operate as the updating unit 16 illustrated in FIG. 4. The CPU 41 reads the information from the information storage area 60 and loads each of the generator 22 and the discriminator 24 on the memory 42. Thus, the computer 40 executes the machine learning program 50 that functions as the machine learning apparatus 10. The CPU 41 that executes the program is hardware.

The functions realized by the machine learning program 50 may instead be realized by, for example, a semiconductor integrated circuit, in more detail, an application-specific integrated circuit (ASIC) or the like.

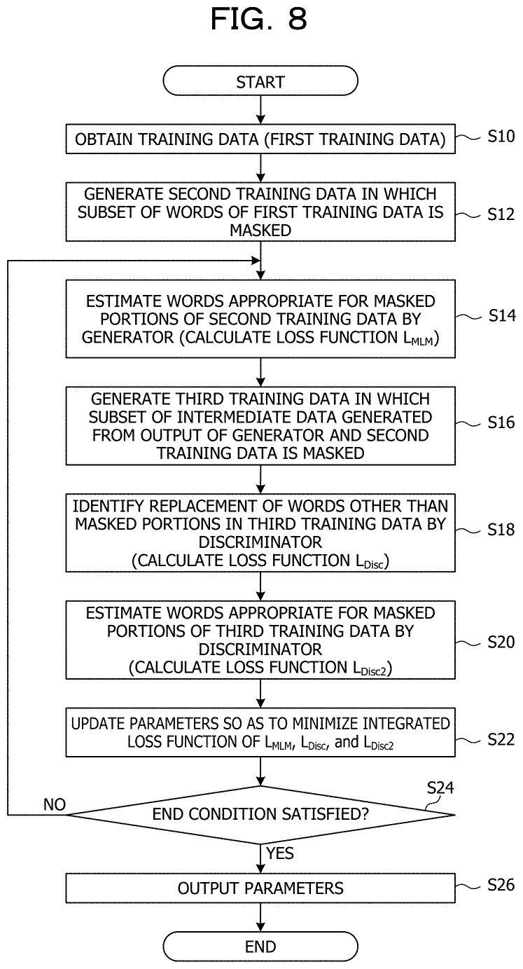

Next, operations of the machine learning apparatus 10 according to the present embodiment will be described. When the training data is input to the machine learning apparatus 10 and it is instructed to generate a pre-trained model, a machine learning process illustrated in FIG. 8 is executed in the machine learning apparatus 10. The machine learning process is an example of a method of machine learning of the disclosed technique.

In operation S10, the first generating unit 12 obtains, as the first training data, training data input to the machine learning apparatus 10. Next, in operation S12, the first generating unit 12 generates the second training data in which a subset of words of the first training data is masked.

Next, in operation S14, the first generating unit 12 inputs the generated second training data to the generator 22. The generator 22 estimates the words appropriate for the masked portions in the second training data and outputs the estimation results. The updating unit 16 calculates the loss function L_{MLM}(x, θ_{G}) based on an error (degree of mismatch) between words in the first training data corresponding to the masked portions in the second training data and the estimation results that is output from the generator 22.

Next, in operation S16, the second generating unit 14 generates intermediate data including the output of the generator 22 to the second training data and words other than the portions masked in the second training data. In the generated intermediate data, the second generating unit 14 generates the third training data in which at least a subset of the words other than the portions masked when the second training data is generated from the first training data is masked.

Next, in operation S18, the second generating unit 14 inputs the generated third training data to the discriminator 24. For words other than the masked portions, the discriminator 24 identifies whether the words replace the first training data (original or replaced) and outputs the identification results. The updating unit 16 obtains correct answers of the presence or absence of replacement in the generator 22 from the words other than the masked portions in the third training data and the corresponding words in the first training data. Then, the updating unit 16 calculates the loss function L_{Disc}(x, θ_{D}) based on an error (degree of mismatch) between the obtained correct answers and the identification results (original or replaced) that are output from the discriminator 24.

Next, in operation S20, the discriminator 24 estimates the words appropriate for the masked portions in the third training data and outputs the estimation results. The updating unit 16 calculates the loss function L_{Disc2}(x, θ_{D}) based on an error (degree of mismatch) between words in the first training data corresponding to the masked portions in the third training data and the estimation results obtained by estimating the masked portions in the discriminator 24.

Next, in operation S22, the updating unit 16 integrates L_{MLM}(x, θ_{G}), L_{Disc}(x, θ_{D}), and L_{Disc2}(x, θ_{D}) by using, for example, the weighted sum to calculate the integrated loss function as represented in Expression (1). The updating unit 16 back-propagates the value of the calculated integrated loss function to the discriminator 24 and the generator 22 and updates the parameters of the generator 22 and the discriminator 24 so as to decrease the value of the integrated loss function.

Next, in operation S24, the updating unit 16 determines whether the end condition of the machine learning is satisfied. In a case where the end condition is not satisfied, the processing returns to operation S14. In a case where the end condition is satisfied, the processing proceeds to operation S26. In operation S26, the updating unit 16 outputs the parameters of the generator 22 and the discriminator 24 obtained when the end condition of the machine learning is satisfied, and the machine learning process ends.

As described above, the machine learning apparatus according to the present embodiment generates the second training data in which a subset of elements of the first training data that includes a plurality of elements is masked. The machine learning apparatus generates, from the second training data, the intermediate data including output of the generator that estimates elements appropriate for the masked portions in the first training data and elements other than the masked portions in the second training data. The machine learning apparatus generates the third training data in which a subset of elements of the generated intermediate data is masked. The machine learning apparatus includes the discriminator. For elements other than the masked portions of the elements out of the third training data, the discriminator identifies whether the elements replace the elements of the first training data and estimates the elements appropriate for the masked portions in the third training data. The machine learning apparatus calculates the integrated loss function by integrating the first loss function, the second loss function, and the third loss function which are calculated based on the output of the generator, the output of the discriminator, and the first training data and which are respectively related to the identification result of the discriminator, the estimation result of the discriminator, and the estimation result of the generator. The machine learning apparatus updates the parameters of the generator and the discriminator so as to minimize the integrated loss function. As described above, the machine learning apparatus according to the present embodiment may increase the complexity of machine learning more than that of the ELECTRA of related art while performing machine learning on the entirety of the input data. Thus, the machine learning apparatus according to the present embodiment may improve the inference accuracy by using the machine learning model having undergone transfer training while maintaining the training speed in machine learning of a pre-trained model usable for transfer training.

Although the case where the parameters of the generator and the discriminator are updated so as to minimize the integrated loss function of L_{MLM}(x, θ_{G}), L_{Disc}(x, θ_{D}), and L_{Disc2}(x, θ_{D}) has been described according to the above embodiment, this is not limiting. For example, first, the parameter of the generator may be updated so as to minimize L_{MLM}(x, θ_{G}). In this case, the parameter of the generator may be fixed, and the parameter of the discriminator may be updated so as to minimize an integrated loss function of L_{Disc}(x, θ_{D}) and L_{Disc2}(X, θ_{D}).

Although a form is described in which the machine learning program is stored (installed) in advance in the storage unit according to the above embodiment, this is not limiting. The program according to the disclosed technique may be provided in a form in which the program is stored in a storage medium such as a compact disc read-only memory (CD-ROM), a Digital Versatile Disc (DVD)-ROM, or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
wherein a subset of elements of first training data that includes a plurality of elements is masked in second training data,
generating, from the second training data, third training data in which a subset of elements of data that includes output of a generator that estimates an element appropriate for a masked portion in the first training data and an element other than the masked portion in the second training data is masked; and
updating a parameter of a discriminator, which identifies whether the element other than the masked portion out of the third training data replaces an element of the first training data and which estimates an element appropriate for the masked portion in the third training data, so as to minimize an integrated loss function obtained by integrating a first loss function and a second loss function that are calculated based on output of the discriminator and the first training data and that are respectively related to an identification result of the discriminator and an estimation result of the discriminator.

2. The non-transitory computer-readable recording medium according to claim 1, wherein, in the generating of the third training data, at least a subset of the elements other than the masked portion in the first training data is masked when the second training data is generated.

3. The non-transitory computer-readable recording medium according to claim 1, wherein the integrated loss function is further integrated with a third loss function related to an estimation result of the generator.

4. The non-transitory computer-readable recording medium according to claim 3, wherein a parameter of the generator is updated so as to minimize the integrated loss function.

5. The non-transitory computer-readable recording medium according to claim 3, wherein the integrated loss function is a weighted sum of the first loss function, the second loss function, and the third loss function.

6. The non-transitory computer-readable recording medium according to claim 5, wherein a weight for the third loss function is smaller than a weight for the first loss function and a weight for the second loss function.

7. The non-transitory computer-readable recording medium according to claim 1, wherein the second training data is generated by masking a subset of elements of the first training data.

8. A machine learning apparatus comprising:
a memory; and
a processor coupled to the memory and configured to:
wherein a subset of elements of first training data that includes a plurality of elements is masked in second training data,
generate, from the second training data, third training data in which a subset of elements of data that includes output of a generator that estimates an element appropriate for a masked portion in the first training data and an element other than the masked portion in the second training data is masked; and
update a parameter of a discriminator, which identifies whether the element other than the masked portion out of the third training data replaces an element of the first training data and which estimates an element appropriate for the masked portion in the third training data, so as to minimize an integrated loss function obtained by integrating a first loss function and a second loss function that are calculated based on output of the discriminator and the first training data and that are respectively related to an identification result of the discriminator and an estimation result of the discriminator.

9. The machine learning apparatus according to claim 8, wherein, in the generating of the third training data, at least a subset of the elements other than the masked portion in the first training data is masked when the second training data is generated.

10. The machine learning apparatus according to claim 8, wherein the integrated loss function is further integrated with a third loss function related to an estimation result of the generator.

11. The machine learning apparatus according to claim 10, wherein a parameter of the generator is updated so as to minimize the integrated loss function.

12. The machine learning apparatus according to claim 10, wherein the integrated loss function is a weighted sum of the first loss function, the second loss function, and the third loss function.

13. The machine learning apparatus according to claim 12, wherein a weight for the third loss function is smaller than a weight for the first loss function and a weight for the second loss function.

14. The machine learning apparatus according to claim 8, wherein the second training data is generated by masking a subset of elements of the first training data.

15. A method of machine learning for causing a computer to execute a process, the process comprising:
wherein a subset of elements of first training data that includes a plurality of elements is masked in second training data,
generating, from the second training data, third training data in which a subset of elements of data that includes output of a generator that estimates an element appropriate for a masked portion in the first training data and an element other than the masked portion in the second training data is masked; and
updating a parameter of a discriminator, which identifies whether the element other than the masked portion out of the third training data replaces an element of the first training data and which estimates an element appropriate for the masked portion in the third training data, so as to minimize an integrated loss function obtained by integrating a first loss function and a second loss function that are calculated based on output of the discriminator and the first training data and that are respectively related to an identification result of the discriminator and an estimation result of the discriminator.

16. The method according to claim 15, wherein, in the generating of the third training data, at least a subset of the elements other than the masked portion in the first training data is masked when the second training data is generated.

17. The method according to claim 15, wherein the integrated loss function is further integrated with a third loss function related to an estimation result of the generator.

18. The method according to claim 17, wherein a parameter of the generator is updated so as to minimize the integrated loss function.

19. The method according to claim 17, wherein the integrated loss function is a weighted sum of the first loss function, the second loss function, and the third loss function.
